(19) United States
(12) Patent Application Publication
(10) Pub. No.: US 2002/0073340 A1
(43) Pub. Date: Jun. 13, 2002

(54) Secure mass storage device with embedded biometri record that blocks access by disabling plug-and-play configuration

(76) Inventors: Sreenath Mambakkam, San Jose, CA (US); Larry Lawson Jones, Palo Alto, CA (US); Arockiyaswamy Venkidu, Menlo Park, CA (US)

Correspondence Address: STUART T AUVINEN, 429 26TH AVENUE, SANTA CRUZ, CA, 95062-5319, US

(21) Appl. No.: 09/681,054

(22) Filed: Dec. 12, 2000

(51) Int. Cl. H04L 9/32; G06F 12/14; G06K 9/00

(52) U.S. Cl. 713/202; 382/115; 713/186

(57) ABSTRACT

An external mass storage device is secured against unauthorized access. A fingerprint reader is integrated on the external mass storage device. An initialization routine is executed when the device is plugged into a personal computer (PC) using a USB, IEEE 1394, PCMCIA, or other interface. The initialization routine scans the user's fingerprint and extracts biometric information. The biometric information is compared to stored biometric records to determine if the user is authorized to access the external mass storage device. When authorization fails, the initialization routine halts, preventing the PC from mounting the external mass storage, thus blocking access. When authentication passes, initialization continues and the external mass storage is mounted and accessible from the PC. Since the initialization routine and stored biometric records are stored on the external mass storage, the external mass storage is protected even when moved to a different PC. Special biometric security software does not have to be installed on the PC.

### BACKGROUND OF INVENTION

This invention relates to external mass storage such as disk drives, and more particularly to secure access of mass storage.

Impressive advances in storage density have enabled larger and more sophisticated programs and data to be stored on computers. Networking has allowed sharing and easy access to large files such as graphics and video clips.

Magnetic storage media such as hard disk drives can store billions of bits of information in a very small package. Solid state storage can also provide storage of large files, although currently at a higher cost.

Computers that are only 2 or 3 years old often seem obsolete as their hard disks fill up. Storage capacities that seemed unlikely to ever be filled when the computer was purchased are quickly occupied by today's larger files and application programs. While some users replace their disk drives to upgrade their computers, others are unwilling or unable to open up their computers to add or replace internal hardware. Thus external mass storage has become popular.

FIG. 1 shows a computer with an external mass storage peripheral or device.

Personal computer (PC) 20 has an internal hard-disk drive and internal dynamic memory that is read by a central processing unit (CPU) when executing programs.

However, since PC 20 was purchased a few years ago, its internal hard disk is close to being filled up with large data and application-program files.

When PC 20 is a desktop PC, the user can open up the chassis to add an extra hard disk drive, although many users do not do so due to technical phobias. When PC 20 is a portable such as laptop or notebook PC, it may not be possible to add an extra internal disk, and replacing the existing disk is difficult and requires that the data on the old disk be backed up first.

To expand the available storage capacity of PC 20, the user attaches external mass storage 12 to PC 20. Expansion ports of PC 20, such as a parallel port, universal-serial bus (USB), IEEE 1394, Personal-Computer Memory Card International Association (PCMCIA), small-computer-system-interface (SCSI), or other generic or proprietary interface receive a plug at an end of a cable from external mass storage 12. Auto-configuration software such as Plug-and-play routines configure external mass storage 12, which appears as an additional disk drive to the user. The user can then store files on external mass storage 12.

While external mass storage 12 is useful, security is an issue. When important files are stored on external mass storage 12, these files can be stolen by theft of external mass storage 12. Since external mass storage 12 is often in a rather small chassis, perhaps only 3 by 5 inches, such theft is facilitated as external mass storage 12 is easier to conceal than the larger PC 20.

In many cases, the thief merely has to plug external mass storage 12 into another PC to read the files stored on external mass storage 12. Although PC 20 may require a password to boot up or access files, when external mass storage 12 is plugged into a different PC, such password protection may be bypassed. Thus the usefulness of external mass storage 12 is limited by its insecure nature.

Biometric devices have been used to secure computers such as PC's. For example, a computer mouse can have a fingerprint reader that scans the user's fingerprint to use for authentication in place of a password. However, the authentication software routines typically reside on the PC or even on a network server. If the fingerprint-reading mouse were moved to a different PC, authentication would not be possible as that PC would not necessarily have the authentication software installed, not would it have a reference fingerprint for the same user. Thus PC-based biometric authentication limits the user to specially-configured PC's or networks of such PC's.

### BRIEF DESCRIPTION OF DRAWINGS

FIG. 1 shows a computer with an external mass storage peripheral or device.

FIG. 2 shows an external mass storage device with an integrated fingerprint reader.

FIG. 3 is a block diagram of an external mass storage device with fingerprint verification.

FIG. 4 shows that the memory on an external mass storage device may include protected and unprotected areas.

FIG. 5 shows an external mass storage with removable media with access secured by fingerprint matching.

FIG. 6 is a diagram of the controller chip for the external mass storage.

FIG. 7 is a flowchart of an installation routine.

FIG. 8 is a flowchart of the initialization routine.

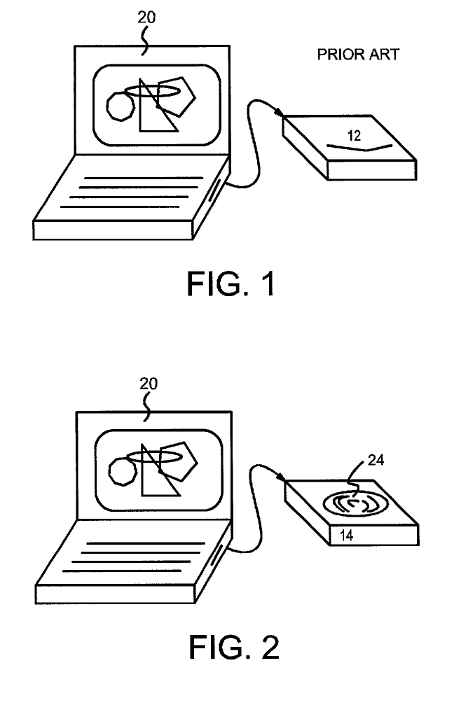

### DETAILED DESCRIPTION

The present invention relates to an improvement in external mass storage. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

FIG. 2 shows an external mass storage device with an integrated fingerprint reader. External mass storage 14 is attached to PC 20 through a cable that is plugged into an expansion plug, such as for a parallel port, universal-serial bus (USB), IEEE 1394, Personal-Computer Memory Card International Association (PCMCIA) or small-computer-system-interface (SCSI).

External mass storage 14 has integrated on its top surface fingerprint reader 24. When a user places his fingertip onto fingerprint reader 24, the lines that make up his fingerprint are read to generate biometric information. This biometric information scanned from fingerprint reader 24 is compared to stored biometric information for authorized users to determine if a sufficient match has occurred.

When such a match occurs, external mass storage 14 is enabled, allowing the user of PC 20 to read files stored on external mass storage 14. When an insufficient match occurs, external mass storage 14 is disabled, preventing access of files stored on it.

Although the user is blocked from reading files on external mass storage 14 when his fingerprint does not match, the user can still access files on the internal drive of PC 20. Thus only access to external mass storage 14 is disabled, allowing use of PC 20 to continue.

The biometric data for authorized users is stored on external mass storage 14, rather than on PC 20. When external mass storage 14 is initialized (booted up), the user must place his finger onto fingerprint reader 24. The initialization routines stored in the firmware of external mass storage 14 extract the biometric information from the scan by fingerprint reader 24 and compare the scanned biometric data to the stored biometric data for authorized users. When no match is found, booting is halted, preventing access of external mass storage 14. PC 20 then reports an error in initialization of external mass storage 14, or simply does not list external mass storage 14 as an available device.

Since fingerprint verification is part of the initialization routine of external mass storage 14 that is stored on external mass storage 14 as firmware, such verification is integral with external mass storage 14. When external mass storage 14 is carried away and plugged into a different PC, fingerprint verification is still required to initialize and access external mass storage 14. Protection of the data stored on external mass storage 14 is thus achieved, even when physical theft of external mass storage 14 occurs.

The storage media of external mass storage 14 can be a hard disk, an optical disk, or a variety of solid-state devices, such as flash memory (electrically-erasable read-only memory, EEPROM) or other non-volatile memory. A combination of storage media may be used, such as a hard disk with a smaller flash memory for the firmware. Additional memory may be used as buffers for buffering data.

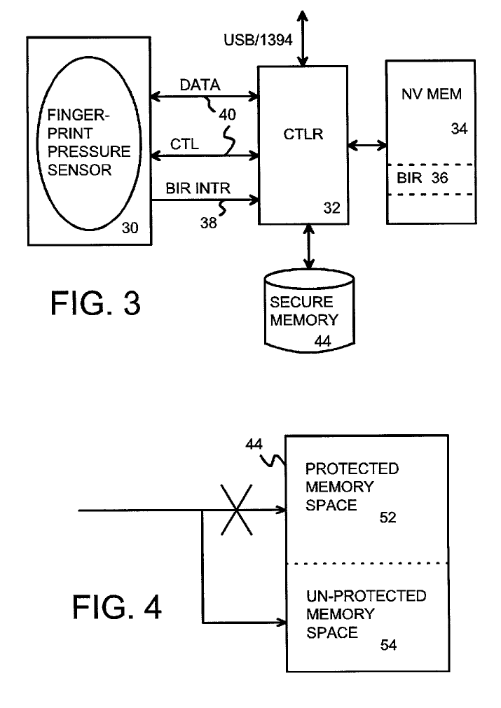

### Block Diagram—FIG. 3

FIG. 3 is a block diagram of an external mass storage device with fingerprint verification. Controller 32 is preferably a microcontroller that executes programmable routines to communicate with a host PC over a communication link such as USB or IEEE 1394. Controller 32 may also contain a hard-disk controller for accessing secure storage 44 when secure storage 44 is a hard disk, or a flash-memory controller when secure storage 44 is a flash memory.

Controller 32 receives biometric data from fingerprint sensor 30, and controller 32 may issue commands to fingerprint sensor 30, such as reset or scan commands over data and control bus 40. Biometric interrupt 38 from fingerprint sensor 30 to controller 32 may be used to signal when a user has pressed his finger against fingerprint sensor 30 or removed his finger. Alternately, controller 32 may periodically poll fingerprint sensor 30 to determine when new biometric data is available.

Fingerprint sensor 30 may be a pressure sensor that detects when a user has inserted his finger into a well of the fingerprint reader. The pressure sensor may have a resolution that is fine enough to obtain the biometric information, or an optical scanner such as a laser may be activated by the pressure sensor to scan the user's finger to obtain the biometric information. Other technologies may also be substituted.

The biometric information can be the raw image of the fingerprint, but preferably it is a more compact representation of the user's fingerprint known as a biometric information record (BIR). Locations where the finger lines or patterns change direction or end can be extracted as the biometric information record. Crossovers, ridge endings, and center points can be included in the BIR. Fingerprint sensor 30 can be a sophisticated device that extracts this BIR information and sends it to controller 32, or the raw data can be sent over data bus 40 to controller 32, and controller 32 can execute routines to extract this condensed BIR information.

The extracted BIR is compared by controller 32 to BIR data for authorized users that is stored in BIR area 36 of non-volatile memory 34. BIR area 36 was written to non-volatile memory 34 during installation of the external mass storage device, when the biometric information of the authorized user or users was captured. Non-volatile memory 34 could be a part of the same physical media as secure storage 44, or it can be a separate memory device such as a flash memory. Non-volatile memory 34 could be a memory in the same semiconductor chip as controller 32, or it can be a separate memory device with a larger storage capacity.

FIG. 4 shows that the memory on an external mass storage device may include protected and unprotected areas. Secure storage 44 may be partitioned into protected memory space 52 and unprotected memory space 54. When authentication fails, such as when the wrong user inserts his finger into the fingerprint reader during initialization of the external mass storage, access to protected memory space 52 is blocked. The firmware of the external mass storage can block all accesses to protected memory space 52, such as by driving some higher-order memory address bits to zero, regardless of the input address from the host PC. This prevents access of upper regions of secure storage 44.

The firmware can still install the external mass storage during initialization, but reduce the size of the memory space reported to the host PC during initialization. Alternately, the firmware could allow access of protected memory space 52, but return dummy data, such as all zeros. Writes to protected memory space 52 would also be blocked.

When initialization fails, access is allowed only to unprotected memory space 54. The size of unprotected memory space 54 can be programmable, and even be determined by the user when external mass storage is first installed. Authorized users that have been authenticated may be allowed to change the size of unprotected memory space 54, or such changes may only be allowed once during installation, or after re-formatting of the storage space.

Having separate protected and un-protected areas of memory increases flexibility. The user may store non-secure data and application programs in unprotected memory space 54, while storing web-site and file passwords, bank and credit card account data, and proprietary company files in protected memory space 52. The user could be asked to insert his finger on the sensor for verification only when accessing data in protected memory space 52. Access to protected memory space 52 could timeout after a predetermined time after verification or the last access or activity.

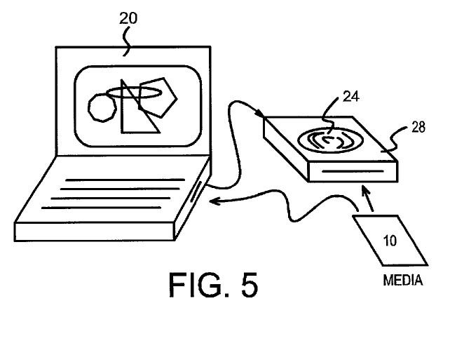

### Removable Secure Media—FIG. 5

FIG. 5 shows an external mass storage with removable media with access secured by fingerprint matching. External mass storage 28 is attached to PC 20 by a cable that plugs into a standard port, such as USB, IEEE 1394, PCMCIA, etc. Removable media 10 contains the storage media, such as a solid-state flash memory card, a removable magnetic or optical disk, or other portable media. When removable media 10 is inserted into a slot in external mass storage 28, a media initialization routine is executed from the firmware, which can be on removable media 10 itself, or on a flash or ROM memory inside external mass storage 28.

During media initialization, firmware on external mass storage 28 causes a message to appear on the screen of PC 20, or otherwise indicates (such as by a blinking light on external mass storage 28) to the user to insert his finger into fingerprint reader 24. Once the user inserts his finger into fingerprint reader 24, authentication is performed using the stored biometric information records of authorized users either on removable media 10 or in external mass storage 28.

When authentication fails, initialization of removable media 10 halts, preventing PC 20 from mounting and accessing it. When authentication passes, removable media 10 is mounted as another disk drive or device that is visible to PC 20. User access can then occur to removable media 10.

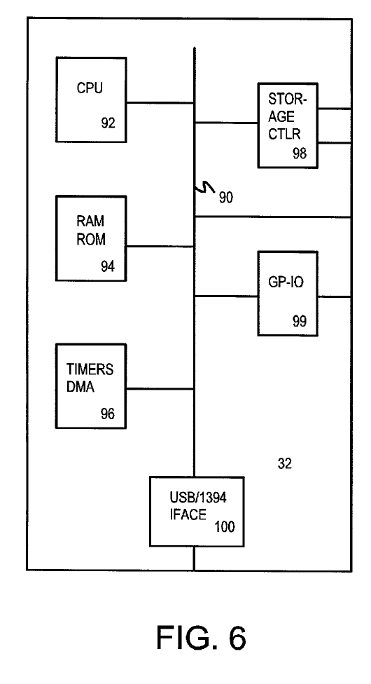

FIG. 6 is a diagram of the controller chip for the external mass storage. Controller 32 can be implemented as a commercially-available micro-controller chip that is programmed to read and write I/O pins that are connected to secure storage media and the USB/1394/PCMCIA interface.

Several different control and transfer routines are written and programmed into RAM/ROM 94. CPU 92 then executes these routines. A high-level scanning routine can sense when a removable media is inserted, or when a finger has been placed onto the fingerprint reader. CPU 92 can then begin execution of another routine to scan and convert the fingerprint, or to read or write the memory. Transfer and handshake sub-routines can then be called.

General-purpose input-output GPIO 99 provides registers or I/O ports that drive external I/O pins of controller 32, or read the logic-levels or voltages on input pins to controller 32. CPU 92 can read registers in GPIO 99 that are written by control signals that are coupled to I/O pins of controller 32 from the fingerprint sensor or secure media. Control signals to the media or sensor can be switched high or low by writing a 1 or a 0 to a register for that control signal in GPIO 99.

Timers 96 are useful for asserting control signals for a required amount of time. For example, a control signal may need to be asserted for a specified number of microseconds. CPU 92 can write a 1 to a register in GPIO 99 and start a timer in timers 96. Timer 6 can sent an interrupt to CPU 96 when the specified time has elapsed, or CPU 92 can continuously or periodically poll timers 96 to determine when the specified time has elapsed. Then CPU 92 can write a 0 to the register in GPIO 99, causing the control signal to transition from 1 to 0.

Media controller 98 is connected to the data and control signals from the secure media. When data is read from the secure memory, a clock or other control signals can be pulsed to synchronize the data transfer. Media controller 98 reads and writes data to the secure media, and performs special disk seek and tracking operations when the secure media is a disk drive. CPU 92 can request re-transmission of data from the secure memory when an error is detected.

Data read by media controller 98 can be sent over internal bus 90 to be stored in a buffer in RAM/ROM 94. Later, CPU 92 can execute a routine to transfer this data from RAM/ROM 94 to USB interface 100. USB interface 100 then transmits the data over an external USB link to a host PC.

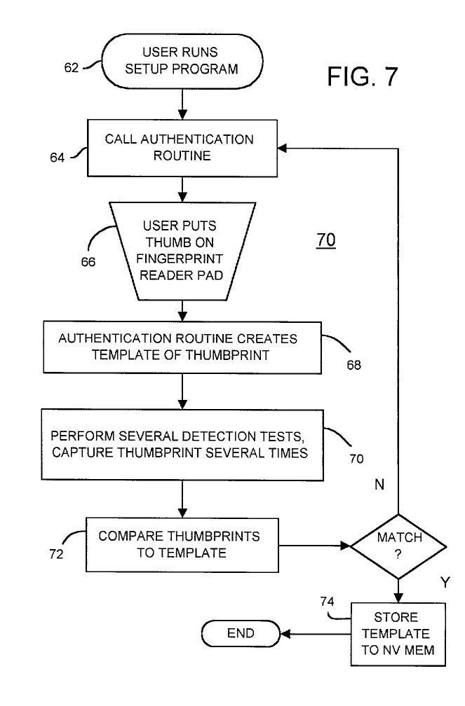

FIG. 7 is a flowchart of an installation routine. Installation routine 70 is run when the external media is re-formatted or first used. Typically the use of the PC executes a setup routine, which may reside on an installation diskette, the PC's hard drive, or on firmware in the external device, or even on the external media itself.

This setup routine is launched by the user, step 62. An authentication routine is called, step 64. This authentication routine typically resides on firmware in the external device rather than on the PC, enhancing security. The user puts his finger on the fingerprint reader, step 66, perhaps after a message is displayed on the PC instructing him to do so. A template of the user's fingerprint is created by the authentication routine, step 68. The fingerprint read by the reader is processed to form the template. The template is in the same format as a biometric information record, in that it contains finger line direction and endpoint data, rather than the actual print itself.

The user is again instructed to insert his finger into the fingerprint reader, and scans are repeatedly taken and converted to biometric data, step 70. The biometric data taken from these repeated detection tests are compared to the template to ensure that the correct biometric data was initially captured. If the repeated scans do not produce the same biometric data, then the template was not correctly obtained, and the initial template is again taken, and steps 64-72 are repeated.

When the biometric data from the repeated detection tests match, the template is written to a non-volatile memory as the biometric information record for the authorized user, step 74. The non-volatile memory can be an area of the larger external media itself, or it can be a special memory such as the memory that also stores the firmware, or a NV memory inside the microcontroller chip. However, the biometric information record is stored on the external mass storage device itself rather than on the PC. Alternatively, the biometric information record may be stored on a secure network server that is accessed by the external mass storage device.

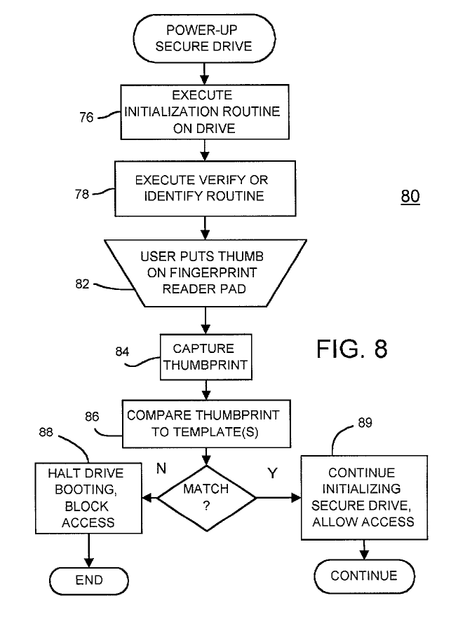

FIG. 8 is a flowchart of the initialization routine. Initialization routine 80 is called when the external mass storage device is plugged into the PC. The Plug-and-play or similar software on the PC's operating system (OS) attempts to auto-configure the external mass storage device when the new connection is detected by the PC. The PC activates the initialization routine that resides on the external mass storage device's firmware, step 76. A verify or an identify sub-routine is called from the firmware memory, step 78. An identify routine is used when more than one authorized user exists, such as when several biometric information records for different authorized users have been stored. The verify routine is used when only one biometric information record is stored and only one authorized user exists.

The user puts his thumb or other finger on the fingerprint reader pad, step 82, perhaps after a message is displayed to the user. The fingerprint is captured by the reader, step 84. The biometric information is extracted from the fingerprint to generate the biometric information, and this biometric information is compared to the stored biometric information record(s) for the authorized user(s). The comparison may require that the match be within a certain threshold of an complete match, allowing for some differences in the biometric data, such as when the user has cut his finger or when a different amount of pressure is applied by the finger. This threshold can be adjusted by the manufacturer or the end user.

When the biometric data does not match within the threshold, authentication fails, and the initialization routine halts execution, step 88. The PC is then unable to mount the external mass storage, so the user is unable to read the external mass storage. Alternatively, the initialization routine can continue, but only allow access to unprotected areas of the external mass storage.

When the biometric data matches within the threshold, the initialization routine continues, step 89, allowing the PC to mount the external mass storage. The external mass storage becomes visible to the PC user, appearing as an additional disk drive or storage device. The user can then read or write the external mass storage, copying files to and from the PC's hard disk to the external mass storage.

### Alternate Embodiments

Several other embodiments are contemplated by the inventors. For example, many embodiments of the controller are possible using one or more chips or software routines. The protected memory may be write-protected but not read-protected to unauthorized users, or all writes may be blocked, even for authorized users. The firmware may be low-level code for the microcontroller that is stored in a ROM such as a flash memory, or a higher-level set of program instructions, or even encoded hardware. The invention may be applied to data transfer devices such as a scanner, printer, video camera, digital camera etc. in which security authentication is required before allowing full access or use of the device. For example, a data transfer device such as a printer might be allowed partial access to print only text documents but not documents with graphics if an authentication match fails. A digital camera could allow only low resolution pictures when the authentication fails.

The fingerprint used may be the user's thumb or index finger, or any other finger, or may include several fingers. Other biometric sensors can be substituted, such as a hand-print reader, a facial geometry, iris, or retina scanner or a voice-print recognizer. The fingerprint sensor could be integrated with an on/off switch, so that the fingerprint is scanned as the user is pressing the ON button to activate the external mass storage device. An ON button is not always needed though, especially for plug-and-play devices.

The user is not required to remember a password, since his biometric information is stored within the device itself. Since the authentication routines are stored in firmware, the device is tamperproof. The device can operate with many different kinds of hosts, such as those running Linux, MacOS, Windows, Solaris, etc. The external device can draw power from the host interface, or an independent power supply can be used.

The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. 37 C.F.R. §1.72(b). Any advantages and benefits described may not apply to all embodiments of the invention. When the word “means” is recited in a claim element, Applicant intends for the claim element to fall under 35 USC §112, paragraph 6. Often a label of one or more words precedes the word “means”. The word or words preceding the word “means” is a label intended to ease referencing of claims elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word means are not intended to fall under 35 USC §112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A secure external mass storage device comprising:
a host interface, for coupling the secure external mass storage device to a host computer, the host computer reading data from the secure external mass storage device through the host interface;
a memory media with a protected memory area, for storing data for access by an authorized user of the host computer;
a biometric reader that generates biometric data from the authorized user; and
a controller that executes an initialization routine, the controller coupled to the biometric reader to accept the biometric data from the biometric reader, the controller comparing the biometric data to a biometric record to determine when the biometric data is for the authorized user, the controller blocking access to the protected memory area when the biometric data is not for the authorized user,
whereby the host computer is blocked from accessing the protected memory area when the biometric reader does not input the biometric data for the authorized user.

2. The secure external mass storage device of claim 1 wherein the biometric record is stored on the memory media or on a firmware memory accessible by the controller;
wherein the initialization routine is stored on the memory media or on a firmware memory accessible by the controller.

3. The secure external mass storage device of claim 2 wherein the biometric record is not stored on the host computer,
wherein when the secure external mass storage device is connected to a different host computer, the initialization routine is executed to compare new biometric data from the biometric reader to the biometric record before authorizing access of the protected memory area,
whereby the secure external mass storage device does not rely on the host computer for security but is secure when connected to other host computers.

4. The secure external mass storage device of claim 2 wherein the controller is part of a microcontroller that includes the firmware memory.

5. The secure external mass storage device of claim 4 further comprising:
a biometric interrupt, generated by the biometric reader when biometric data is available, for signaling the controller to read the biometric data.

6. The secure external mass storage device of claim 2 wherein the memory media also comprises an unprotected memory area;
wherein the controller allows access of the unprotected memory area but not the protected memory area when the biometric data is not for the authorized user.

7. The secure external mass storage device of claim 2 wherein the biometric reader is a fingerprint reader, a hand-print reader, a facial geometry scanner, an iris reader, a retina scanner, or a voice-print recognizer.

8. The secure external mass storage device of claim 2 wherein the host interface is for connection to a port on the host computer that uses a universal-serial bus (USB), IEEE 1394, Personal-Computer Memory Card International Association (PCMCIA), parallel port, or small-computer-system-interface (SCSI) protocol.

9. The secure external mass storage device of claim 2 wherein the memory media is a magnetic disk, an optical disk, or a solid-state memory.

10. The secure external mass storage device of claim 9 wherein the memory media is removable from the secure external mass storage device,
wherein the initialization routine is activated when the memory media is inserted into the secure external mass storage device or when the host interface is connected to the host computer.

11. A method for securing an external mass storage comprising:
activating an initialization routine when an external mass storage device is connected to a host;
executing the initialization routine stored in the external mass storage device by reading a firmware memory containing the initialization routine;
activating a biometric input to capture biometric information from a user; comparing the biometric information to a biometric record for an authorized user to determine when the biometric information matches within a threshold;
when the biometric information matches, continuing to execute the initialization routine to mount the external mass storage to the host, allowing the host to access protected data in the external mass storage; and
when the biometric information does not match, halting execution of the initialization routine to prevent mounting of the external mass storage to the host, preventing the host from accessing protected data in the external mass storage,
whereby the initialization routine authenticates biometric information when the external mass storage is connected to the host.

12. The method of claim 11 further comprising:
reading the biometric record from non-volatile memory in the external mass storage device,
whereby the biometric record for the authorized user is stored on the external mass storage device.

13. The method of claim 11 wherein the external mass storage accepts a removable media containing the protected data;
wherein the initialization routine is activated when the removable media is plugged into the external mass storage device.

14. The method of claim 11 further comprising:
activating a biometric interrupt to signal the initialization routine when the biometric input captures the biometric information.

15. The method of claim 11 wherein several authorized users have biometric records stored on the external mass storage device;
further comprising:
comparing the biometric information to a plurality of biometric records to find a closest match, and allowing access to the protected data when the closest match is within the threshold.

16. The method of claim 11 further comprising:
when a first use of the external mass storage occurs, executing an installation routine, the installation routine:
activating the biometric input to capture biometric information from a new user;
forming a biometric template from the biometric information; re-activating the biometric input to capture additional biometric information from the new user;
comparing the additional biometric information to the biometric template for the new user to determine when the additional biometric information matches within a threshold;
when the biometric information matches, storing the biometric template as the biometric record for the new user, the new user being the authorized user; and
when the biometric information does not match, re-activating the biometric input to re-capture the biometric information from the new user and replacing the biometric template with a new biometric template, re-activating the biometric input and capturing and comparing the additional biometric information to verify the new biometric template, whereby the biometric template for the new user is stored upon installation.

17. An external peripheral comprising:
host interface means for coupling the external peripheral to a host computer;
controller means, coupled to the host interface means, for executing programmable routines;
memory means, coupled to the controller means, for storing data from the host computer, the memory means having protected memory means for storing data for access by an authorized user of the host computer; and
biometric reader means, coupled to the controller means, for generating biometric data from the authorized user;
the controller means for accepting the biometric data from the biometric reader means, comparing the biometric data to a biometric record to determine when the biometric data is for the authorized user, and for blocking access to the protected memory means when the biometric data is not for the authorized user,
whereby the host computer is blocked from accessing protected memory when the biometric data is not for the authorized user.

18. The external peripheral of claim 17 wherein the controller means including an execution means for executing instructions, a code memory means for storing the programmable routines, and a storage controller means for accessing the memory means.

19. The external peripheral of claim 18 wherein the biometric record is stored in the code memory means.

20. The external peripheral of claim 17 wherein the biometric record comprises data for locations where finger lines or patterns change direction or end.
